(19) United States
(12) Patent Application Publication
(10) Pub. No.: US 2019/0286225 A1
(43) Pub. Date: Sep. 19, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Genki OSADA, Kanagawa (JP)

(73) Assignee: FUJI XEROX CO., LTD., Tokyo (JP)

(21) Appl. No.: 16/167,543

(22) Filed: Oct. 23, 2018

(30) Foreign Application Priority Data
Mar. 19, 2018 (JP) 2018-050719

(51) Int. Cl. G06F 3/01; G06N 7/00; G06F 15/18

(52) U.S. Cl. CPC G06F 3/011; G06F 2203/011; G06F 15/18; G06N 7/005

(57) ABSTRACT

An information processing apparatus includes plural detectors each of which detects a physical amount of a subject; a setting unit that sets, for each of the detectors, a detection period of the physical amount used for estimation; and an estimation unit that estimates feelings of the subject in accordance with the physical amount detected by each of the plural detectors in the detection period set by the setting unit. The setting unit sets a detection period used for next estimation on the basis of an estimation result obtained by the estimation unit.

### CROSS-REFERENCE TO RELATED APPLICATIONS

This application is based on and claims priority under 35 USC 119 from Japanese Patent Application No. 2018-050719 filed Mar. 19, 2018.

### BACKGROUND

### Technical Field

The present disclosure relates to an information processing apparatus and a non-transitory computer readable medium.

Japanese Unexamined Patent Application Publication No. 2016-115057 aims to provide a biological information processing system, a server system, a biological information processing apparatus, a biological information processing method, and a program that make it possible to know a user's mental state corresponding to lifelog information. The biological information processing system includes a biological information acquisition unit that acquires biological information measured by a biological sensor, a processing unit that estimates user's metal state information on the basis of the biological information, and a memory in which lifelog information is stored. The processing unit gives, as an index, the mental state information estimated on the basis of the biological information to lifelog information, and the lifelog information to which the mental state information has been given as an index is stored in the memory.

Japanese Unexamined Patent Application Publication No. 2010-279638 aims to provide a lifelog recording device that makes it possible to easily extract information necessary for a user. The lifelog recording device that records thereon at least one of user's moving path information, motion state information, life state information, and ambient environment information concerning an ambient environment during movement includes a detection unit that detects at least one of the moving path information, the motion state information, the life state information, and the ambient environment information, a memory in which various kinds of information detected by the detection unit are stored, a unique situation determination unit that determines whether or not a situation is a unique situation on the basis of the various kinds of information detected by the detection unit, and an importance adding unit that adds information concerning importance to the various kinds of information stored in the memory in a case where the unique situation determination unit determines that the situation is a unique situation.

### SUMMARY

Physical amounts of a subject are detected by using plural sensors in order to estimate human feelings. However, a physical amount detection period suitable for estimation varies depending on a sensor, and it is difficult to set such a detection period.

Aspects of non-limiting embodiments of the present disclosure relate to an information processing apparatus and a non-transitory computer readable medium that make it possible to set a detection period of a physical amount used for estimation of feelings of a subject by using an estimation result.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including plural detectors each of which detects a physical amount of a subject; a setting unit that sets, for each of the detectors, a detection period of the physical amount used for estimation; and an estimation unit that estimates feelings of the subject in accordance with the physical amount detected by each of the plural detectors in the detection period set by the setting unit. The setting unit sets a detection period used for next estimation on the basis of an estimation result obtained by the estimation unit.

### BRIEF DESCRIPTION OF THE DRAWINGS

An exemplary embodiment of the present disclosure will be described in detail based on the following figures, wherein:

FIG. 1 is a conceptual module configuration diagram concerning an example of a configuration according to the present exemplary embodiment;

FIG. 2 is an explanatory view illustrating an example of a system configuration using the present exemplary embodiment;

FIG. 3 is a flowchart illustrating an example of processing according to the present exemplary embodiment;

FIG. 4 is an explanatory view illustrating an example of a data structure of a detection data table;

FIG. 5 is an explanatory view illustrating an example of a data structure of longest detection period data;

FIG. 6 is an explanatory view illustrating an example of a data structure of a detection period table;

FIG. 7 is an explanatory view illustrating an example of processing according to the present exemplary embodiment;

FIGS. 8A and 8B are explanatory views illustrating an example of processing according to the present exemplary embodiment;

FIGS. 9A and 9B are explanatory views illustrating an example of processing according to the present exemplary embodiment;

FIGS. 10A through 10B3 are explanatory views illustrating an example of processing according to the present exemplary embodiment;

FIGS. 11A1 through 11A3 are explanatory views illustrating an example of processing according to the present exemplary embodiment;

FIGS. 12A1 through 12A4 are explanatory views illustrating an example of processing according to the present exemplary embodiment;

FIG. 13 is an explanatory view illustrating an example of a data structure of a schedule information table; and

FIG. 14 is a block diagram illustrating an example of a hardware configuration of a computer that realizes the present exemplary embodiment.

### DETAILED DESCRIPTION

An example of an exemplary embodiment of the present disclosure is described below with reference to the drawings.

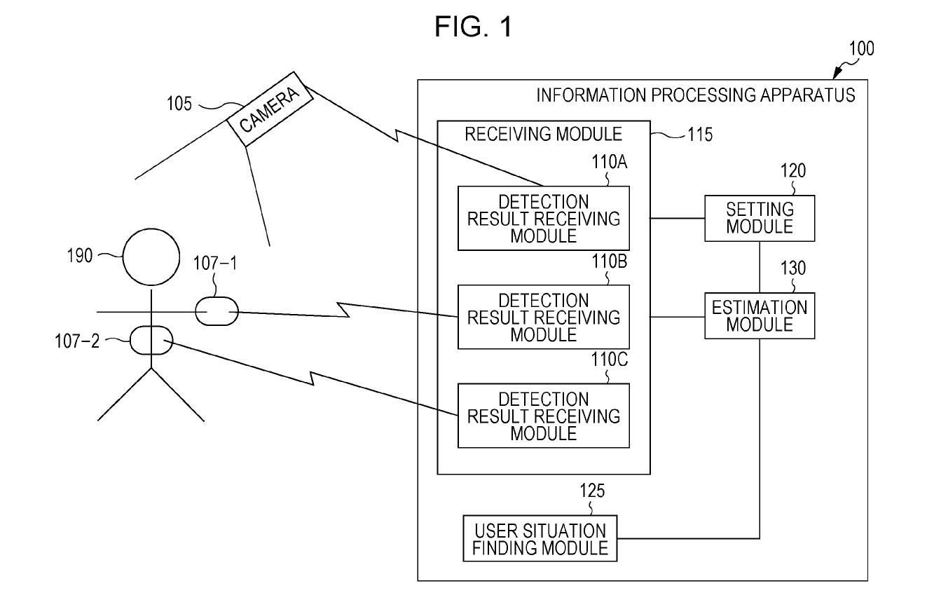

FIG. 1 is a conceptual module configuration diagram concerning an example of a configuration according to the present exemplary embodiment.

The “module” generally refers to logically independent software (a computer program) or a component such as hardware. Accordingly, a module according to the present exemplary embodiment refers to not only a module as a computer program, but also a module as a hardware configuration. Therefore, the present exemplary embodiment also serves as descriptions of a computer program for causing a computer to function as a module (a program for causing a computer to execute a procedure, a program for causing a computer to function as a unit, or a program for causing a computer to realize a function), a system, and a method. For convenience of description, “store”, “stored”, and equivalent terms are used, but these terms mean that a computer program is stored in a storage device or control is performed so that a computer program is stored in a storage device in a case where the exemplary embodiment is a computer program. Although a module may correspond to a function on a one-to-one basis, a single module may be constituted by a single program, plural modules may be constituted by a single program, or a single module may be constituted by plural programs. Furthermore, plural modules may be executed by a single computer or a single module may be executed by plural computers in a distributed or parallel environment. A single module may include another module. Hereinafter, “connection” refers to not only physical connection, but also logical connection (e.g., data exchange, an instruction, a reference relationship between data, login). The term “predetermined” refers to being determined before subject processing and encompasses not only being determined before start of processing according to the present exemplary embodiment, but also being determined before subject processing even after start of the processing according to the present exemplary embodiment in accordance with a situation or a state at the time or in accordance with a situation or a state so far. In a case where there are plural “predetermined values”, the predetermined values may be different values or two or more of the predetermined values (including all of the predetermined values) may be identical to each other. The expression “in a case where A, B is performed” means that “whether A or not is determined, and in a case where it is determined that A, B is performed” except for a case where it is unnecessary to determine whether A or not. An expression listing plural things such as “A, B, C” is listing of examples unless otherwise specified and encompasses a case where only one of them (e.g., only A) is selected.

A system or an apparatus may be constituted not only by plural computers, hardware configurations, apparatuses, or the like that are connected through means of communication such as a network (including one-to-one communication connection), but also by a single computer, hardware configuration, apparatus, or the like. The terms “system” and “apparatus” are uses synonymously. Needless to say, the term “system” does not encompass a social “mechanism” (social system) that is an artificial arrangement.

For each of processes performed by modules or for each of processes performed by a module in a case where plural processes are performed within the module, target information is read from a storage device, and a result of the process is written into the storage device after the process. Description of reading of the information from the storage device before the process and writing into the storage device after the process is sometimes omitted. Examples of the storage device may include a hard disk, a random access memory (RAM), an external storage medium, a storage device connected through a communication line, and a register in a central processing unit (CPU).

An information processing apparatus 100 according to the present exemplary embodiment is for estimating human feelings and includes a receiving module 115, a setting module 120, a user situation finding module 125, and an estimation module 130 as illustrated in FIG. 1. Physical amounts (also called sensing data) of a subject 190 are detected by using plural sensors (also called sensor devices) in order to estimate feelings of the subject 190.

Human feelings to be sensed are factors causing occurrence of sensing data (assumed to be factors causing occurrence of sensing data). Feelings are estimated by analyzing sensing data as time-series data. It is therefore necessary to decide a sensing period (a detection period, specifically the number of frames).

It is however difficult to set an optimum period for the following reasons:

(1) The number of frames optimum for estimation varies depending on a modal.

When human feelings change, facial expression, voice, and a body temperature react to the change in different ways (at different speeds).

(2) The number of frames optimum for estimation varies depending on a scene even in a case where the same person and the same modal are used.

In the present exemplary embodiment, a detection period is adjusted for each modal to a detection period suitable for the modal.

For example, a frame necessary for estimation of feelings is controlled by applying a filter (a value [0, 1]) to an input frame set.

A shape of the filter is dynamically generated on the basis of past sensing data (e.g., sensing data obtained several minutes ago or several seconds ago).

The shape of the filter is generated for each modal.

There are plural kinds of detection devices that detect a physical amount of the subject 190. Examples of such a detection device include a camera 105 and sensors 107. For example, such a detection device is a sensor called a multimodal (also called a multimodal interface). The detection device may be a single sensor that has plural functions or may be a combination of plural kinds of sensors.

The camera 105 is connected to a detection result receiving module 110A of the receiving module 115 provided in the information processing apparatus 100. The camera 105 photographs the subject 190.

The sensors 107 (a sensor 107-1, a sensor 107-2, and the like) are connected to a detection result receiving module 110B of the receiving module 115 provided in the information processing apparatus 100. The sensors 107 detect a physical amount of the subject 190. Examples of the sensors 107 include a microphone, an acceleration sensor, a temperature sensor, a sphygmomanometer, a sphygmometer, and the like. Examples of the sensors 107 may include a mouse, a keyboard, a touch panel, and the like that receive operation of the subject 190. The sensors 107 may be carried by the subject 190 or may be wearable sensors.

Specifically, human sensing of a certain person (the subject 190) may be performed by using plural kinds of sensors such as a camera specialized for tracking of feature points of a face, a surface temperature sensor, and a microphone. In this context, feature points of a face, a surface temperature, voice data, and the like are each called a modal (physical amount), and a sensor and a modal may correspond to each other on a one-to-one basis.

The receiving module 115 includes the detection result receiving module 110A, the detection result receiving module 110B, a detection result receiving module 110C, and the like and is connected to the setting module 120 and the estimation module 130. The receiving module 115 receives a detection result obtained by a detection device. For example, the receiving module 115 may receive a detection result by communicating with the detection device through a communication line. This communication line may be a wired communication line, a wireless communication line, or a combination thereof. Alternatively, the receiving module 115 may read out a detection result obtained by a detection device from a storage medium (e.g., a USB memory) in which the detection result is stored.

Each of the detection result receiving modules 110 (the detection result receiving module 110A, the detection result receiving module 110B, the detection result receiving module 110C, and the like) is connected to the camera or the sensors 107. Each of the detection result receiving modules 110 acquires a physical amount of the subject 190 detected by the camera 105 or the sensors 107.

For example, the detection result receiving module 110A acquires an image from the camera 105. Furthermore, the detection result receiving module 110A acquires voice data from a microphone that is a detection device.

The detection result receiving modules 110 may analyze data acquired by the detection devices and use the data as feature data (modal).

The setting module 120 is connected to the receiving module 115 and the estimation module 130. The setting module 120 sets, for each detection device, a detection period of a physical amount used for estimation.

The setting module 120 sets a detection period used for next estimation on the basis of an estimation result obtained by the estimation module 130.

The setting module 120 may set a detection period for each kind of detection device.

The setting module 120 may set a detection period for each kind of detection device after setting a longest detection period for all of the detection devices. Specifically, processing for (1) setting a longest detection period common to all modals and (2) applying a filter for each modal is performed.

The setting module 120 may use a filter that decides a detection period. The filter may decide a detection period by using a threshold value.

A shape of the filter may be dynamically generated on the basis of a past physical amount. The “past” physical amount is, for example, a physical amount obtained several minutes ago or several seconds ago.

A cumulative Gaussian distribution may be used as a filter. Specifically, the setting module 120 may generate a filter that is a cumulative Gaussian distribution by deciding an average and a dispersion of a Gaussian distribution by using an estimation result and a physical amount used for estimation and set a detection period that is larger than a threshold value or is equal to or larger than a threshold value. The “average of the Gaussian distribution” decides a position of the filter on a time axis, and the “dispersion of the Gaussian distribution” decides an attenuation gradient of the filter.

The setting module 120 may set a period in accordance with an estimation result and a situation of the subject 190. Examples of the “situation of the subject 190” include presentation, brainstorming, and deskwork.

The user situation finding module 125 is connected to the estimation module 130. The user situation finding module 125 finds a situation (including a scene) of the subject 190 in accordance with a position or schedule of the subject 190. The “position” may be, for example, latitude, longitude, or a room name. The “situation” is, for example, an activity which a person (the subject 190) to be sensed is performing or an environment in which the person is engaged (e.g., presentation, brainstorming, or deskwork).

For example, the user situation finding module 125 may specify a current position or a current situation by acquiring positional information from a GPS of a mobile terminal carried by the subject 190 or acquiring schedule information of the subject 190.

The estimation module 130 is connected to the receiving module 115, the setting module 120, and the user situation finding module 125. The estimation module 130 estimates feelings of the subject 190 in accordance with physical amounts detected by the plural detection devices in detection periods set by the setting module 120. An existing technique may be used to estimate feelings from sensing data.

Furthermore, the estimation module 130 may estimate feelings of the subject 190 by using a situation of the subject 190 found by the user situation finding module 125. As for the expression “find a situation in accordance with a position of a subject”, for example, it may be found that the situation is presentation, brainstorming, or the like in a case where the position is a conference room, and it may be found that the situation is deskwork or the like in a case where the position is an office room.

As for the expression “find a situation in accordance with schedule of a subject”, for example, it may be found that the situation is presentation, brainstorming, or the like in a case where the subject is scheduled at a current time to be participating in a conference, and it may be found that the situation is deskwork or the like in a case where no schedule is present at a current time.

The estimation module 130 may estimate feelings of the subject 190 by using a model generated by machine learning. For example, a model may be generated by machine learning using, as learning data, a combination of detection results (physical amounts) obtained by the camera 105 and the sensors 107 in a case where feelings are known.

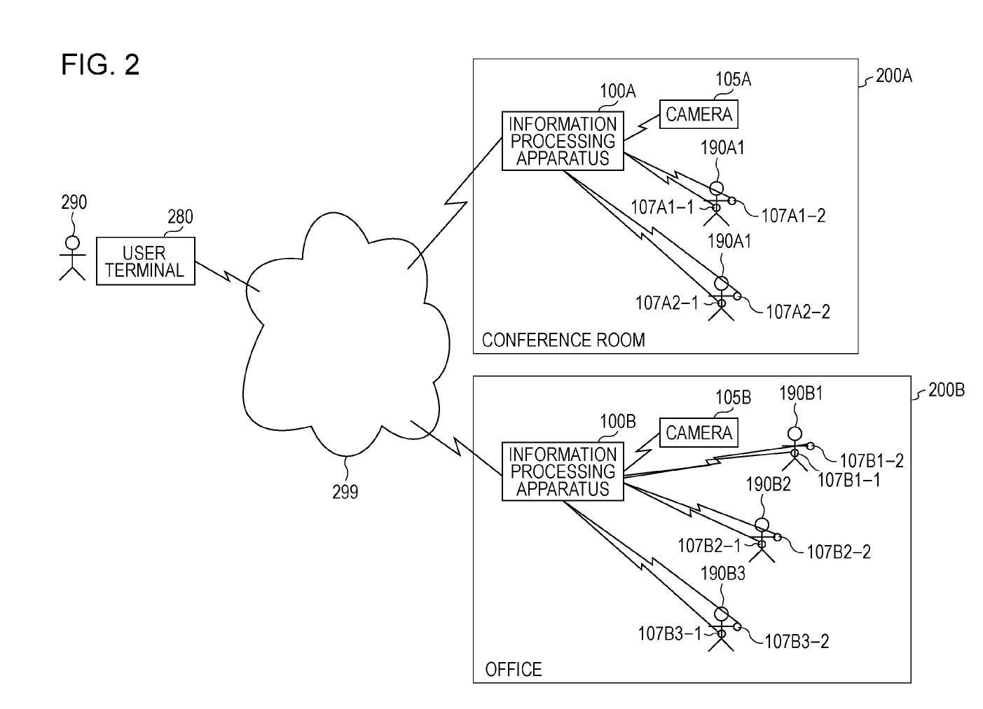

FIG. 2 is an explanatory view illustrating an example of a system configuration using the present exemplary embodiment.

A user terminal 280, an information processing apparatus 100A, and an information processing apparatus 100B are connected to one another through a communication line 299. The communication line 299 may be a wireless communication line, a wired communication line, or a combination thereof and may be, for example, the Internet, an intranet, or the like that serves as a communication infrastructure. A function of the information processing apparatus 100 may be realized as a cloud service.

The information processing apparatus 100A and a camera 105A are provided in a conference room 200A, and a subject 190A1 and a subject 190A2 are present in the conference room 200A. A sensor 107A1-1 and a sensor 107A1-2 are attached to the subject 190A1. A sensor 107A2-1 and a sensor 107A2-2 are attached to the subject 190A2. The information processing apparatus 100A estimates feelings of the subject 190A1 and the subject 190A2 and then transmits a result of the estimation to the user terminal 280.

The information processing apparatus 100B and a camera 105B are provided in an office 200B, and a subject 190B1, a subject 190B2, and a subject 190B3 are present in the office 200B. A sensor 107B1-1 and a sensor 107B1-2 are attached to the subject 190B1. A sensor 107B2-1 and a sensor 107B2-2 are attached to the subject 190B2. A sensor 107B3-1 and a sensor 107B3-2 are attached to the subject 190B3. The information processing apparatus 100B estimates feelings of the subject 190B1, the subject 190B2, and the subject 190B3 and then transmits results of the estimation to the user terminal 280.

The user terminal 280 receives the results of the estimation of the feelings from the information processing apparatus 100A and the information processing apparatus 100B and presents the results to a user 290, for example, by using a display device.

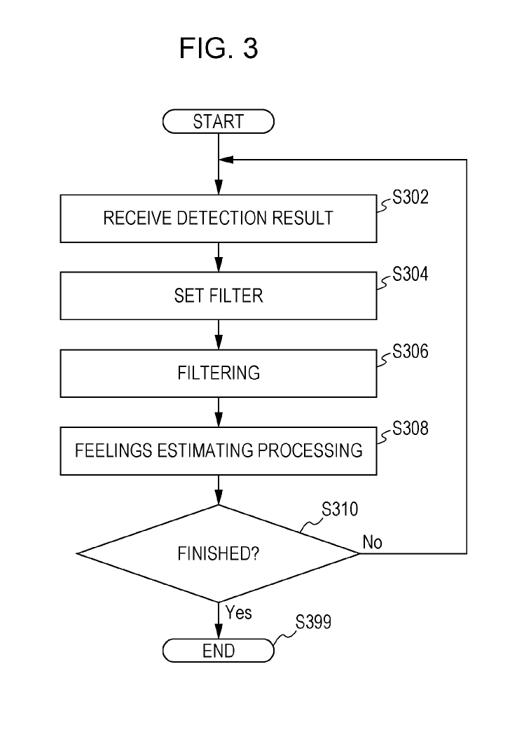

FIG. 3 is a flowchart illustrating an example of processing according to the present exemplary embodiment.

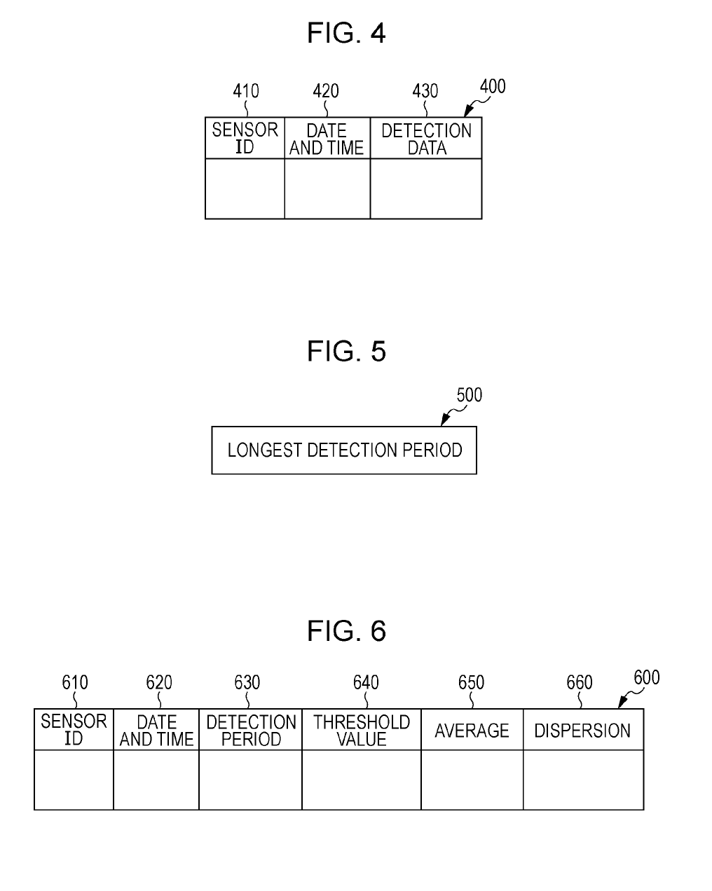

In Step S302, the detection result receiving modules 110 of the receiving module 115 receive detection results, for example, from the camera 105 and the sensors 107. For example, the detection result receiving modules 110 receive a detection data table 400. FIG. 4 is an explanatory view illustrating an example of a data structure of the detection data table 400. The detection data table 400 has a sensor ID field 410, a date and time field 420, and a detection data field 430. In the present exemplary embodiment, the sensor ID field 410 stores therein information (sensor ID: IDentification) for uniquely identifying a detection device (the camera 105, the sensors 107, or the like). The date and time field 420 stores therein date and time (a year, a month, a date, an hour, a minute, a second, a time unit smaller than a second, or a combination thereof) of sensor's detection. The detection data field 430 stores therein detection data obtained by the sensor.

In Step S304, the setting module 120 sets a filter by using a result of last estimation.

Specifically, the following processing is performed.

A longest detection period common to all of the modals (the detection devices) is set. This longest detection period is determined in advance. For example, longest detection period data 500 is set in the estimation module 130.

For example, 30 seconds is set as the longest detection period in the longest detection period data 500. This means that feelings are estimated every time 30-second sensing data is input. Note that estimated feelings are also referred to as a latent variable.

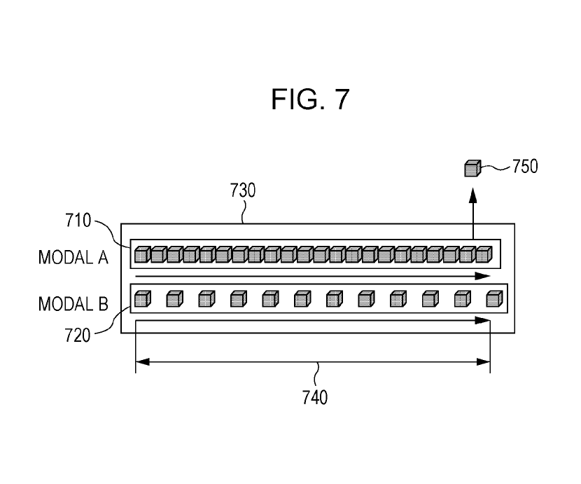

In general, the sensor 107-1 and the sensor 107-2 are different in sensing frequency and are therefore different in the number of times of detection (specifically, the number of frames) that corresponds to 30 seconds. This is described with reference to FIG. 7. FIG. 7 is an explanatory view illustrating an example of processing according to the present exemplary embodiment. In FIG. 7, a step function is used as a filter.

A longest period 740 is a value set in the longest detection period data 500. The sensor 107-1 (Modal A in FIG. 7) outputs modal sensing data A710 during the longest period 740. The sensor 107-2 (Modal B in FIG. 7) outputs modal sensing data B720 during the longest period 740. As for the sensor 107-1, which has a higher sensing frequency than the sensor 107-2, the number of pieces of measurement data in the modal sensing data A710 is larger than the number of pieces of measurement data in the modal sensing data B720.

The estimation module 130 outputs an estimated potential factor 750 by using the modal sensing data A710 and the modal sensing data B720 (sensing data 730). The estimated potential factor 750 is feelings estimated by the estimation module 130.

In Step S306, the estimation module 130 performs filtering.

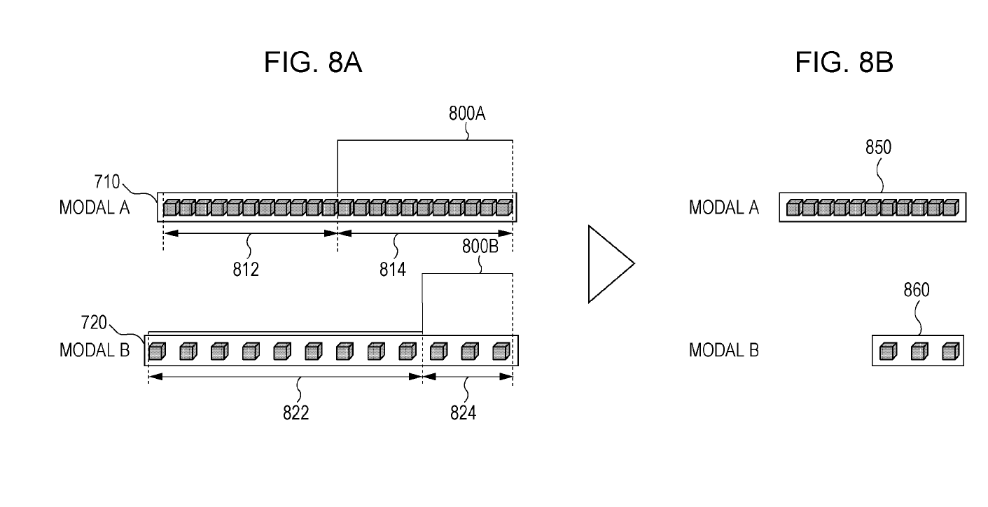

This is described below with reference to the example of FIGS. 8A and 8B. FIGS. 8A and 8B are explanatory views illustrating an example of processing according to the present exemplary embodiment. FIGS. 8A and 8B illustrate an example in which a filter is applied for each modal.

Specifically, a filter 800A is applied to the modal sensing data A710. This filter 800A divides the modal sensing data A710 into a non-detection period 812 and a detection period 814. This detection period 814 serves as extracted sensing data 850 and is used for estimation of feelings. A filter 800B is applied to the modal sensing data B720. This filter 800B divides the modal sensing data B720 into a non-detection period 822 and a detection period 824. This detection period 824 serves as extracted sensing data 860 and is used for estimation of feelings.

In Step S308, the estimation module 130 performs processing for estimating feelings.

In Step S310, the estimation module 130 determines whether or not the processing has been finished, and ends the processing in a case where the processing has been finished (Step S399), and Step S302 is performed again in other cases.

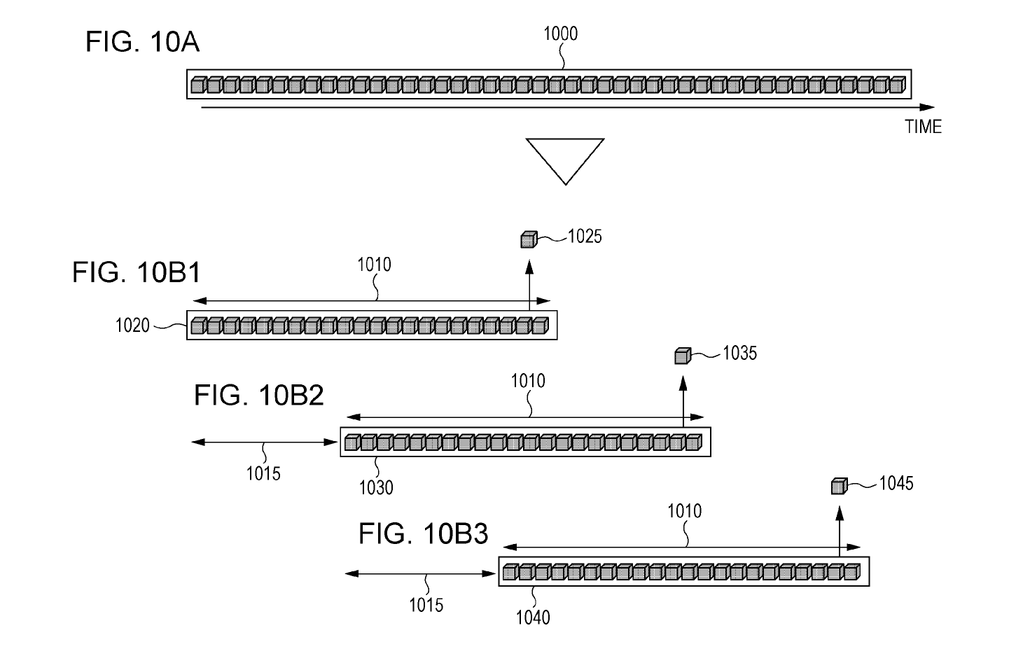

A shape of a filter and a threshold value are managed in a detection period table 600. FIG. 6 is an explanatory view illustrating an example of a data structure of the detection period table 600. The detection period table 600 has a sensor ID field 610, a date and time field 620, a detection period field 630, a threshold value field 640, an average field 650, and a dispersion field 660. Each row of the detection period table 600 is used for a single estimation process. The sensor ID field 610 stores therein a sensor ID. Accordingly, a filter is decided for each detection device. The date and time field 620 stores therein date and time. The date and time in the date and time field 620 are date and time of detection of detection data at the top of a longest detection period 1010 illustrated in the example of FIGS. 10A through 10B3. That is, the longest detection period 1010 illustrated in the example of FIGS. 10A through 10B3 is specified by a value in the date and time field 620 and a value in the longest detection period data 500. The detection period field 630 stores therein a detection period of a corresponding detection device. This detection period is decided by a filter that is device by data in the average field 650 and the dispersion field 660 used for the last estimation and a threshold value in the threshold value field 640. The threshold value field 640 stores therein a threshold value. The average field 650 stores therein an average of detection data in a corresponding detection period. The dispersion field 660 stores therein a dispersion value of detection data in a corresponding detection period. A threshold value may be fixed for each detection device. In this case, the threshold value field 640 of the detection period table 600 may be deleted, as long as a correspondence table indicative of correspondences between detection devices and threshold values is prepared.

Although a step function is used as a filter (the filter 800A and the filter 800B) in the example of FIGS. 8A and 8B, the following filter may be used.

A filter satisfies the followings:

(1) A filter is parametric.

This intends to make a shape of a filter controllable by adjustment of a small number of parameters. Adjustment is easier as the number of parameters is small. In an example that will be described later, a shape of a filter is adjusted by using, as parameters, an average and a dispersion value of sensing data used in last estimation of feelings.

(2) A filter is differentiable.

This is because learning is performed by a gradient method.

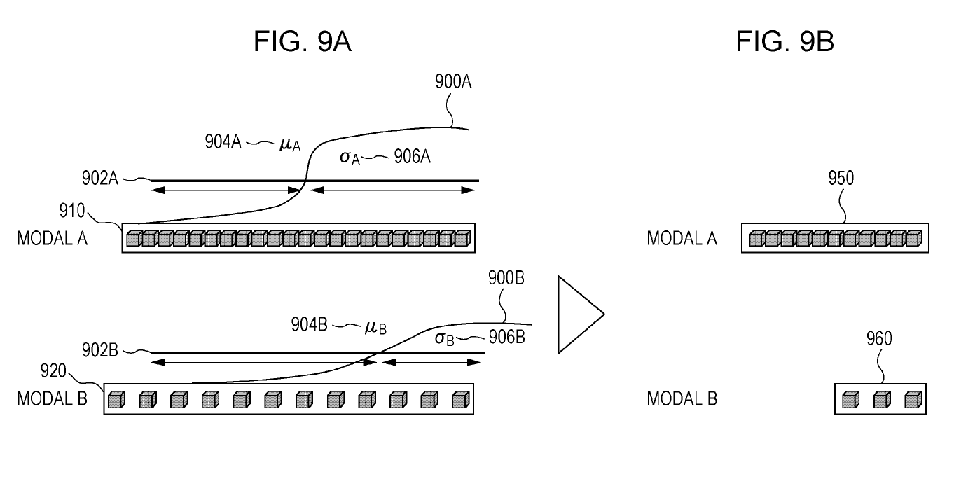

Specifically, a cumulative Gaussian distribution is used. This is described below with reference to FIGS. 9A and 9B. FIGS. 9A and 9B are explanatory views illustrating an example of processing according to the present exemplary embodiment.

(1) A threshold value γ is set. The threshold value γ is, for example, 0.1. In the example of FIG. 9A, a threshold value 902A and a threshold value 902B are the threshold value γ.

(2) An average (μ) and a dispersion (σ) of a Gaussian distribution are dynamically decided from past data. A position of a filter on a time axis is decided by μ, and an attenuation gradient of the filter is decided by σ. This will be described later in detail. The process for deciding μ and σ is performed both at a time of machine learning and at a time of test (operation). In the example of Modal A in FIG. 9A, a shape of a filter 900A is decided by an average 904A and a dispersion 906A. That is, a position of the filter 900A on a time axis (a position in a left-right direction in the example of FIGS. 9A and 9B) is decided by the average 904A, and an attenuation gradient (a degree of slope from a left end to a right end of the filter 900A in the example of FIGS. 9A and 9B) is decided by the dispersion 906A. Similarly, in the example of Modal B in FIG. 9A, a shape of the filter 900B is decided by an average 904B and a dispersion 906B. That is, a position of the filter 900B on a time axis (a position in a left-right direction in the example of FIGS. 9A and 9B) is decided by the average 904B, and an attenuation gradient (a degree of slope from a left end to a right end of the filter 900B in the example of FIGS. 9A and 9B) is decided by the dispersion 906B.

(3) A cumulative Gaussian distribution is generated by using μ and σ, and detection data (frame) for which a probability (value of a filter) is equal to or larger than γ is used as input data. In the example of Modal A in FIG. 9A, the modal sensing data A910 is divided at a point at which the threshold value 902A divides the filter 900A (an intersection of the filter 900A and the threshold value 902A). Feelings are estimated by using a right part (extracted sensing data 950 illustrated in the example of FIG. 9B) of the modal sensing data A910 as input data. Similarly, the modal sensing data B920 is divided at a point at which the threshold value 902B divides the filter 900B (an intersection of the filter 900B and the threshold value 902B). Feelings are estimated by using a right part (extracted sensing data 960 illustrated in the example of FIG. 9B) of the modal sensing data B920 as input data.

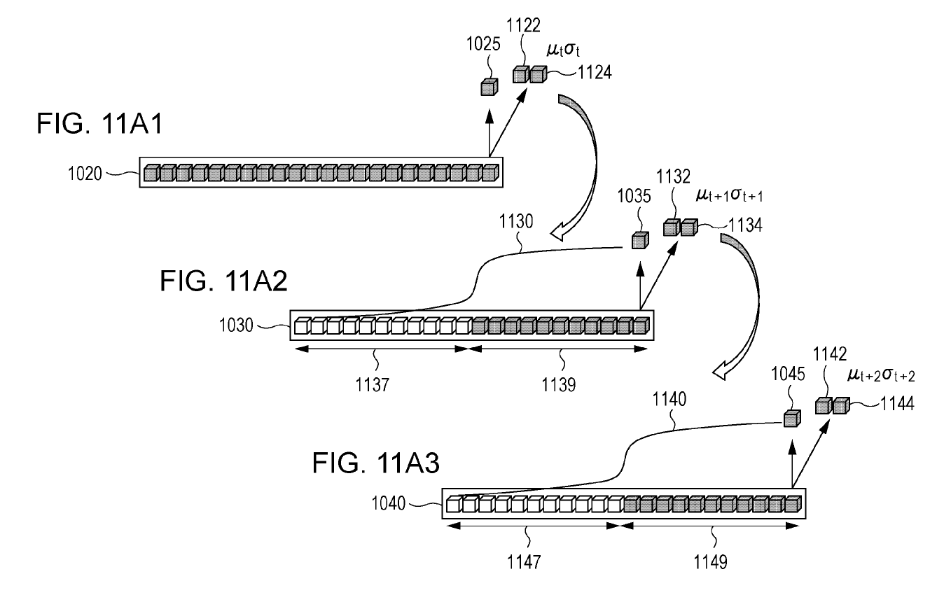

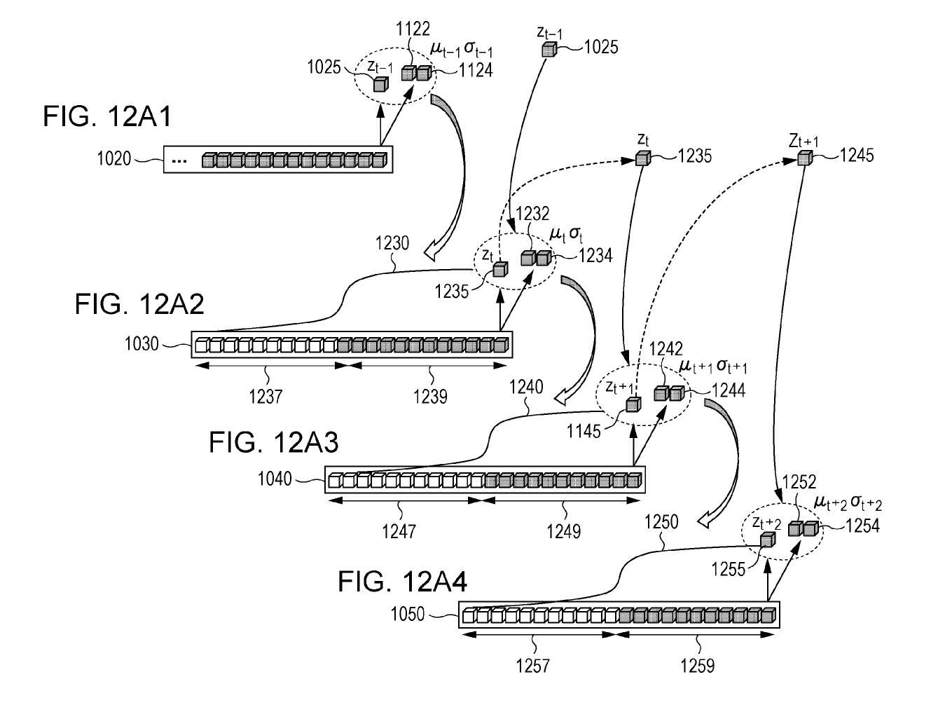

Next, generation of an average (μ) and a dispersion (σ) is described by using the example of FIGS. 10A through 10B3, FIGS. 11A1 through 11A3, and FIGS. 12A1 through 12A4. FIGS. 10A through 10B3 are explanatory views illustrating an example of processing according to the present exemplary embodiment. Specifically, FIGS. 10A through 10B3 illustrate an example of processing for extracting target data in generation of the average (μ) and dispersion (σ).

Sensing data 1000 illustrated in the example of FIG. 10A is a detection result obtained by a detection device and is sensing data before filtering. This sensing data 1000 is divided by a longest detection period. How much time (or how many frames) are shifted is decided by a shift amount 1015. The shift amount 1015 is a predetermined value.

Specifically, first, as illustrated in the example of FIG. 10B1, sensing data 1020 corresponding to a longest detection period 1010 is extracted starting from the start of the sensing data 1000. An estimated potential factor 1025 is output by using the sensing data 1020 (the whole data in the sensing data 1020 need not necessarily be used).

Next, as illustrated in the example of FIG. 10B2, sensing data 1030 corresponding to the longest detection period 1010 is extracted from the sensing data 1000 starting from a position shifted by the shift amount 1015 from a left end of the sensing data 1020. An estimated potential factor 1035 is output by using the sensing data 1030 (the whole data in the sensing data 1030 need not necessarily be used).

Next, as illustrated in FIG. 10B3, sensing data 1040 corresponding to the longest detection period 1010 is extracted from the sensing data 1000 starting from a position shifted by the shift amount 1015 from a left end of the sensing data 1030. An estimated potential factor 1045 is output by using the sensing data 1040 (the whole data in the sensing data 1040 need not necessarily be used).

Next, an average (μ) and a dispersion (σ) are generated. FIGS. 11A1 through 11A3 are explanatory views illustrating an example of processing according to the present exemplary embodiment. Specifically, an average (μ) and a dispersion (σ) are generated after filtering is performed by the estimation module 130.

As illustrated in FIG. 11A1, from data in the sensing data 1020 illustrated in the example of FIG. 10B1, an average 1122 and a dispersion 1124 are calculated and the estimated potential factor 1025 is output. Since the sensing data 1020 is initial sensing data, filtering is not performed (or filtering of extracting the whole sensing data is performed).

A shape of a next filter 1130 is decided by using the average 1122 and the dispersion 1124. Then, as illustrated in the example of FIG. 11A2, data in the sensing data 1030 illustrated in the example of FIG. 10B2 is filtered by using the filter 1130. This divides the sensing data 1030 into a non-detection period 1137 and a detection period 1139. By using the detection period 1139, an average 1132 and a dispersion 1134 are calculated and the estimated potential factor 1035 is output.

Similarly, a shape of a next filter 1140 is decided by using the average 1132 and the dispersion 1134. Then, as illustrated in the example of FIG. 11A3, data in the sensing data 1040 illustrated in the example of FIG. 10B3 is filtered by using the filter 1140. This divides the sensing data 1040 into a non-detection period 1147 and a detection period 1149. By using the detection period 1149, an average 1142 and a dispersion 1144 are calculated and the estimated potential factor 1045 is output. A similar process is performed thereafter.

The following describes generation of an average (μ) and a dispersion (σ) using a method different from the method of FIGS. 11A1 through 11A3. FIGS. 12A1 through 12A4 are explanatory views illustrating an example of processing according to the present exemplary embodiment. Specifically, a shape of a next filter is decided by also using an estimation result (e.g., an estimated potential factor 1235 in FIGS. 12A1 through 12A4).

This is described by using the example of FIG. 12A3.

A shape of a filter 1240 is decided by using previous average 1232 and dispersion 1234. Filtering is performed by using the filter 1240. This divides the sensing data 1040 into a non-detection period 1247 and a detection period 1249. By using the detection period 1249, an average 1242 and a dispersion 1244 are calculated and an estimated potential factor 1245 is output. The average 1242, the dispersion 1244, and the estimated potential factor 1245 are adjusted by using the estimated potential factor 1235. Specifically, it is only necessary to input the estimated potential factor 1235 in machine learning and generate a mode for adjusting the average 1242, the dispersion 1244, and the estimated potential factor 1245. That is, the average 1242 and the dispersion 1244 are not just an average and a dispersion of the detection period 1249 and have been adjusted by the estimated potential factor 1235. Then, a shape of a filter 1250 is decided by using the average 1242 and the dispersion 1244 as a next step, and a similar process is performed thereafter. A process before FIG. 12A3 is also performed in a similar manner.

In the example of FIGS. 12A1 through 12A4, values of average and dispersion (e.g., the average 1242 and the dispersion 1244) are adjusted by using a previous estimation result (e.g., the estimated potential factor 1235) in order to decide a shape of a filter. However, values of average and dispersion may be adjusted by using not only a previous estimation result, but also a situation of a subject.

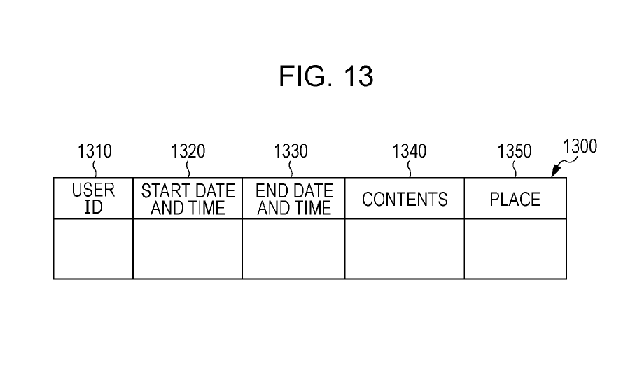

A specific example of such a situation of a subject is a schedule information table 1300. FIG. 13 is an explanatory view illustrating an example of a data structure of the schedule information table 1300. The schedule information table 1300 has a user ID field 1310, a start date and time field 1320, an end date and time field 1330, a contents field 1340, and a place field 1350. The user ID field 1310 stores therein a user ID of a user who is the subject 190. In the start date and time field 1320 and subsequent fields, schedule information of the user is stored. The start date and time field 1320 stores therein date and time of start of the schedule. The end date and time field 1330 stores therein date and time of end of the schedule. The contents field 1340 stores therein contents of the schedule. The place field 1350 stores therein a place of the schedule.

The setting module 120 acquires the schedule information table 1300 corresponding to the subject 190, for example, from a schedule management device. Then, the setting module 120 may adjust values of average and dispersion that decide a shape of a filter by using data in the contents field 1340 or the place field 1350 in the schedule information table 1300 that correspond to current date and time. Specifically, it is only necessary to prepare a model for adjusting an average and a dispersion by inputting a previous estimation result, data in the contents field 1340, and data in the place field 1350 in machine learning. Furthermore, a model for adjusting an estimation result obtained this time, an average, and a dispersion may be prepared by inputting a previous estimation result, data in the contents field 1340, and data in the place field 1350.

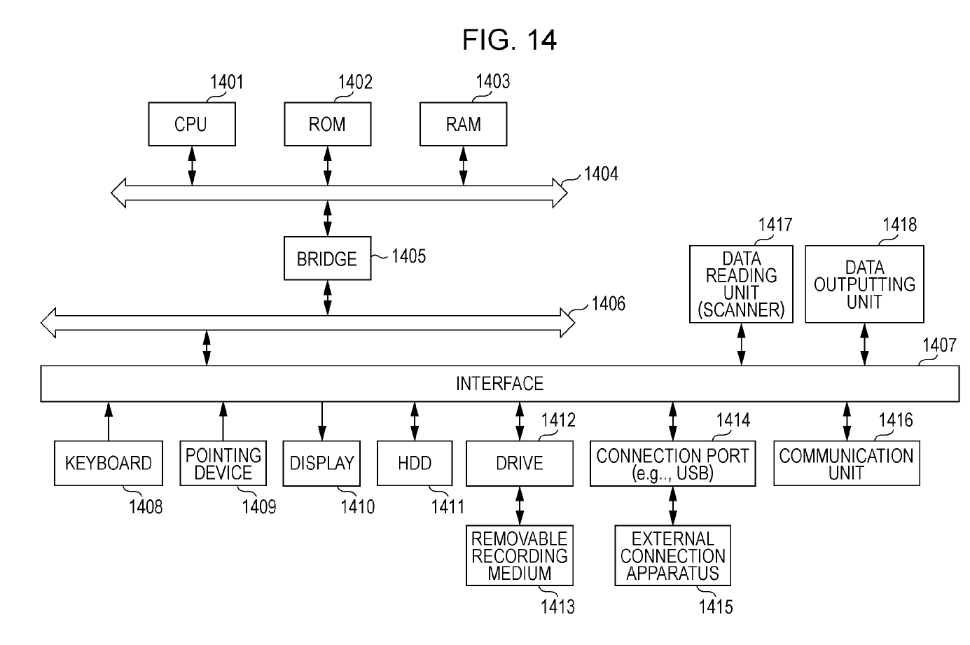

An example of a hardware configuration of the information processing apparatus 100 according to the present exemplary embodiment is described below with reference to FIG. 14. FIG. 14 illustrates an example in which the information processing apparatus 100 is, for example, a personal computer (PC) and includes a data reading unit 1417 such as a scanner and a data output unit 1418 such as a printer.

A central processing unit (CPU) 1401 is a controller that performs processing in accordance with a computer program describing execution sequences of various kinds of modules described in the above exemplary embodiment, i.e., modules such as a detection result receiving module 110, the receiving module 115, the setting module 120, the user situation finding module 125, and the estimation module 130.

A read only memory (ROM) 1402 stores therein a program, an arithmetic parameter, and the like used by the CPU 1401. A random access memory (RAM) 1403 stores therein a program used for execution of the CPU 1401, a parameter that changes as appropriate in the execution, and the like. These members are connected to one another through a host bus 1404 that is, for example, a CPU bus.

The host bus 1404 is connected to an external bus 1406 such as a peripheral component interconnect/interface (PCI) bus through a bridge 1405.

A keyboard 1408 and a pointing device 1409 such as a mouse are devices operated by an operator. A display 1410 is, for example, a liquid crystal display device or a cathode ray tube (CRT) and displays various kinds of information as text or image information. The display 1410 may be, for example, a touch screen or the like having both of the function of the pointing device 1409 and the function of the display 1410. In this case, a physical keyboard such as the keyboard 1408 need not necessarily be connected, and a function of a keyboard may be realized by drawing a keyboard (also called a software keyboard or a screen keyboard) by using software on a screen (a touch screen).

A hard disk drive (HDD) 1411 includes a hard disk (may be a flash memory or the like) and records or reproduces a program executed by the CPU 1401 and information by driving the hard disk. The hard disk stores therein detection results obtained by the various sensors 107, an image taken by the camera 105, the detection data table 400, the longest detection period data 500, the detection period table 600, an estimation result, and the like. Furthermore, other various kinds of data, various computer programs, and the like are stored.

A drive 1412 reads out data or a program recorded in a removable recording medium 1413 in the drive 1412, such as a magnetic disc, an optical disc, a magnetooptical disc, or a semiconductor memory and supplies the data or the program to the RAM 1403 connected through an interface 1407, the external bus 1406, the bridge 1405, and the host bus 1404. The removable recording medium 1413 is usable as a data recording region.

A connection port 1414 is a port for connection with an external connection apparatus 1415 and has a connection part such as a USB or IEEE1394. The connection port 1414 is connected to the members such as the CPU 1401 through the interface 1407, the external bus 1406, the bridge 1405, the host bus 1404, and the like. A communication unit 1416 is connected to a communication line and performs processing for data communication with an outside. The data reading unit 1417 is, for example, a scanner and performs document reading processing. The data output unit 1418 is, for example, a printer and performs document data output processing.

The hardware configuration of the information processing apparatus 100 illustrated in FIG. 14 is merely an example, and the present exemplary embodiment is not limited to the configuration illustrated in FIG. 14, provided that the modules described in the present exemplary embodiment are executable. For example, some of the modules may be constituted by dedicated hardware (e.g., an application specific integrated circuit (ASIC)), some of the modules may be provided in an external system and be connected through a communication line, or plural systems illustrated in FIG. 14 may be connected through a communication line so as to operate in cooperation with one another. In particular, the modules may be incorporated not only into a personal computer, but also into a mobile information communication apparatus (examples of which include a mobile phone, a smartphone, a mobile apparatus, and a wearable computer), an information household appliance, a robot, a copying machine, a facsimile apparatus, a scanner, a printer, a multifunction printer (an image processing apparatus that has functions of two or more of a scanner, a printer, a copying machine, a facsimile apparatus, and the like), or the like.

The program described above may be provided by being stored in a recording medium or may be provided through a means of communication. In this case, for example, the program described above may be grasped as an invention of a “computer readable medium storing a program”.

The “computer readable medium storing a program” is a computer readable medium storing a program used for install, execution, distribution, and the like of the program.

Examples of the recording medium include digital versatile discs (DVDs) such as “DVD-R, DVD-RW, and DVD-RAM” that are standards set in a DVD forum and “DVD+R and DVD+RW” that are standards set in DVD+RW, compact discs (CDs) such as a read-only memory (CD-ROM), a CD recordable (CD-R), and a CD rewritable (CD-RW), a Blu-ray (registered trademark) disc, a magnetooptic disc (MO), a flexible disc (FD), a magnetic tape, a hard disk, a read-only memory (ROM), an electrically erasable programmable read-only memory (EEPROM (registered trademark)), a flash memory, a random access memory (RAM), and a secure digital (SD) memory card.

The whole or part of the program may be, for example, stored or distributed by being recorded on the recording medium. The program may be transferred by using a transfer medium such as a wired network or a wireless communication network used for a local area network (LAN), a metropolitan area network (MAN), a wide area network (WAN), the Internet, an intranet, an extranet, or the like, or a combination thereof or may be carried on a carrier wave.

Furthermore, the program described above may be part or all of another program or may be recorded on a recording medium together with a different program. Alternatively, the program described above may be recorded in plural recording media in a distributed manner. Alternatively, the program described above may be recorded in any form (e.g., in a compressed form or an encrypted form) as long as the program can be restored.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a plurality of detectors each of which detects a physical amount of a subject;
a setting unit that sets, for each of the detectors, a detection period of the physical amount used for estimation; and
an estimation unit that estimates feelings of the subject in accordance with the physical amount detected by each of the plurality of detectors in the detection period set by the setting unit,
wherein the setting unit sets a detection period used for next estimation on a basis of an estimation result obtained by the estimation unit.

2. The information processing apparatus according to claim 1, wherein
the detectors are a plurality of kinds of detectors; and
the setting unit sets, for each of the plurality of kinds of detectors, the detection period.

3. The information processing apparatus according to claim 2, wherein
the setting unit sets, for each of the plurality of kinds of detectors, the detection period after setting a longest detection period for all of the detectors.

4. The information processing apparatus according to claim 2, wherein
the setting unit uses a filter that decides the detection period; and
the filter decides the detection period by using a threshold value.

5. The information processing apparatus according to claim 4, wherein
a shape of the filter is dynamically generated on a basis of a past physical amount.

6. The information processing apparatus according to claim 5, wherein
a cumulative Gaussian distribution is used as the filter; and
the setting unit generates the filter that is the cumulative Gaussian distribution by deciding an average and a distribution of a Gaussian distribution by using the estimation result and a physical amount used for estimation and sets a detection period that is equal to or larger than the threshold value.

7. The information processing apparatus according to claim 1, wherein
the setting unit sets the detection period in accordance with the estimation result and a situation of the subject.

8. The information processing apparatus according to claim 7, further comprising a finding unit that finds a situation of the subject in accordance with a position or schedule of the subject,
wherein the estimation unit estimates feelings of the subject by using the situation of the subject found by the finding unit.

9. The information processing apparatus according to claim 1, wherein
the estimation unit estimates feelings of the subject by using a model generated by machine learning.

10. A non-transitory computer readable medium storing an information processing program causing a computer to function as:
a plurality of detectors each of which detects a physical amount of a subject;
a setting unit that sets, for each of the detectors, a detection period of the physical amount used for estimation; and
an estimation unit that estimates feelings of the subject in accordance with the physical amount detected by each of the plurality of detectors in the detection period set by the setting unit,
wherein the setting unit sets a detection period used for next estimation on a basis of an estimation result obtained by the estimation unit.

11. An information processing apparatus comprising:
a plurality of detection means each for detecting a physical amount of a subject;
setting means for setting, for each of the detectors, a detection period of the physical amount used for estimation; and
estimation means for estimating feelings of the subject in accordance with the physical amount detected by each of the plurality of detectors in the detection period set by the setting means,
wherein the setting means sets a detection period used for next estimation on a basis of an estimation result obtained by the estimation means.
